(19) United States
(12) Patent Application Publication
(10) Pub. No.: US 2008/0246607 A1
(43) Pub. Date: Oct. 9, 2008

(54) METHOD OF DETECTING LOCK BUMPING

(75) Inventor: RICHARD A SMITH, EL DORADO HILLS, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/042,491

(22) Filed: Mar. 5, 2008

Related U.S. Application Data
(60) Provisional application No. 60/922,596, filed on Apr. 9, 2007.

(51) Int. Cl. E05B 45/00

(52) U.S. Cl. 340/542

(57) ABSTRACT

A method of detecting an attempted lock bumping and providing a notification that an attempted lock bumping has occurred. A lock bumping detection device is placed on or in a door or door jamb near the lock. The device includes a sensor which senses energy and generates a signal that is processed to determine if the energy is a result of a lock bumping procedure. The sensed energy is analyzed to generate a received energy signature, which is compared to a stored energy signature with respected to qualifying and disqualifying rules. If the result of the comparison is positive, this indicates that the energy sensed is a result of an attempted lock bumping procedure. In the event that it is determined that the energy is a result of an attempted lock bumping procedure, then an alarm signal may be transmitted to an associated alarm system.

### CROSS-REFERENCE TO RELATED APPLICATION

This application claims filing priority from co-pending provisional application Ser. No. 60/922,596, filed on Apr. 9, 2007.

### TECHNICAL FIELD

This invention relates to security systems, and in particular to a security system device that detects if a lock bumping procedure has been attempted on the lock of an entry door.

### BACKGROUND ART

Recently, information about lock bumping, which is a lock picking technique, has been released in the media and documented on the Internet. This technique has been a closely held secret of locksmiths for years, and the release of this information is a security issue to everyone who uses a pin tumbler lock, which is a lock that is opened with a metal key. This technique requires very little skill level and can be used by anyone. The technique involves inserting a bump key into the lock and tapping the bump key one or more times with a mallet (or similar device) while applying a slight turning force to the bump key. A bump key is made from a regular key or a key blank. Each grove of the key blank is easily filed down to the lowest groove level, and the shoulder of the key is filed so the key can be pushed further forward. There are many web sites on the Internet that show users how to make and use a bump key.

Lock bumping works because of the way locks in ninety percent of all households are constructed. These locks, called pin-tumbler locks, contain a series of spring-loaded stacks. Each stack has two pins, a key pin and a driver pin, which are stacked on top of each other. The key pin is the bottom pin that touches the inserted key, and the driver pin is the pin that sits on top of the key pin and is pushed down by a spring. When the actual key of the lock is inserted, all of the key pins, which are different lengths, are pushed up by the key an amount equal to the level of the grooves in the key. This causes the driver pins in each stack to push against the springs an amount equal to the level of the grooves in the key. For the longer key pins, the level of the groove is lower; and for the shorter key pins, the level of the groove is higher so that when the key is inserted a shearline is formed where the space between the key pin and the drive pin is aligned for all stacks. Once the shearline is created, the cylinder can be turned and the lock opened. When no key or the wrong key is in the lock, the springs pushes against the drive pins causing the shearline to be misaligned due to the different sizes of the key pins, which prevents the cylinder from being turned. To perform the lock bumping, the bump key, which has the lowest groove levels, is inserted into the lock and withdrawn by one pin. The user taps the back of the key which bumps the key pins and causes the driver pins to bounce up against the spring (similar to billiard balls hitting each other). This action causes a momentary gap between the key pin and the drive pin which generates a shearline for a brief instance, and if the user turns the cylinder in that instance the lock will open.

Lock bumping is worse than a typical house break-in because when there is no evidence of a break-in the insurance companies may claim that the door was left unsecured by the homeowner. As a result, the insurance companies are not reimbursing the homeowner for their losses. At the present time, the only countermeasure to lock bumping is to change the lock to a combination lock or a magnetic lock. This option is expensive and may not be desirable to the homeowner.

An alarm system may prevent the premises from being broken into because an alarm will sound when the intruder doesn't enter a proper security code shortly after opening the door. However, for homeowners that do not have an alarm system, forget to enable their alarm system, or have an alarm system that is disabled automatically with the turning of the lock cylinder, lock bumping is a significant problem.

It is therefore an object of the present invention to provide an alarm device that detects the occurrence of an attempted lock bumping procedure.

It is a further object of the present invention to provide an alarm device that provides an indication of an alarm after it detects the occurrence of a lock bumping procedure.

It is a further object of the present invention to provide an alarm device that registers and/or indicates a lock bumping procedure has been attempted.

Finally it is a further object of the present invention to provide an alarm device that is able to communicate with an alarm system to signal the occurrence of lock bumping procedure to the alarm system.

### DISCLOSURE OF THE INVENTION

The present invention is a method of detecting a lock bumping procedure and notifying an authorized person (e.g. a homeowner or business owner, or a central station operator) that the lock bumping procedure has occurred. The method includes placing a lock bumping detection device on or in a door near the door lock, or on or in a door jamb near the door lock. The lock bumping detection device includes a sensor such as an acoustic sensor which senses acoustic energy (e.g. a microphone), a shock sensitive transducer (e.g. a MEMs accelerometer), or a piezoelectric effect sensor which detects seismic transmissions. The signal from the sensor is amplified and processed to determine if the energy sensed is a result of an attempted lock bumping procedure. In the event that it is determined that the sensed energy is a result of an attempted lock bumping procedure, then an alarm signal may be transmitted to an associated alarm system. The alarm signal may be sent whether or not the lock bumping procedure is successful, i.e. the mere attempt to open the lock via lock bumping will trigger the alarm.

In order to determine if the energy is sensed as a result of a lock bumping procedure, the signal from the sensor is analyzed to generate a received energy signature. The received energy signature is then compared to a stored energy signature with respect to sets of qualifying rules and disqualifying rules. If the result of the comparison is positive (i.e. a qualifying rule is met), this indicates that the energy sensed is a result of an attempted lock bumping procedure. Conversely, if the result of the comparison is negative (i.e. a qualifying rule is not met and/or a disqualifying rule is met), this indicates that the energy sensed is not a result of an attempted lock bumping procedure. To determine the received energy signature, for example, the processing circuitry looks for a sequence of events where the energy in particular frequency bands and the timing between the detected frequencies is in a unique pattern. For the present invention, the received energy signature is produced as a result of the intruder banging the bump key, the bump key hitting the key pins, the key pins hitting the drive pins, and finally the turning of the cylinder (or it may include the bump key shoulder hitting the lock cylinder, and/or the bump key reaching maximum travel). If a lock bumping procedure has been detected by the signature analysis, the security device will illuminate an LED indicator and/or transmit an alarm signal to an associated alarm system.

The stored energy signature and qualifying and disqualifying rules are initially obtained by simulating a lock bumping procedure on a lock, then sensing the energy emanating from the lock, then analyzing the sensed energy to generate an energy signature, and then storing the energy signature in memory. This is then used as the baseline against which subsequent received energy signatures will be compared to ascertain if a lock bumping procedure has been attempted.

An alternative embodiment of the security device may be achieved by the use of analog electronics rather than digital processing. In this embodiment multiple narrow band filters, comparator circuits, and timing and delay circuits detect the sequence of events described above.

### BRIEF DESCRIPTION OF THE DRAWING

FIG. 1 is a flow diagram of the method of the present invention.

FIG. 2 is a diagram of the security device of the present invention.

FIG. 3 is a flow diagram of the processing performed by the processor of the security device.

FIG. 4 is a diagram of an alternative embodiment of the present invention.

FIG. 5 illustrates the analysis of the received signature and the stored signature with respect to the qualifying and disqualifying rules.

### BEST MODE FOR CARRYING OUT THE INVENTION

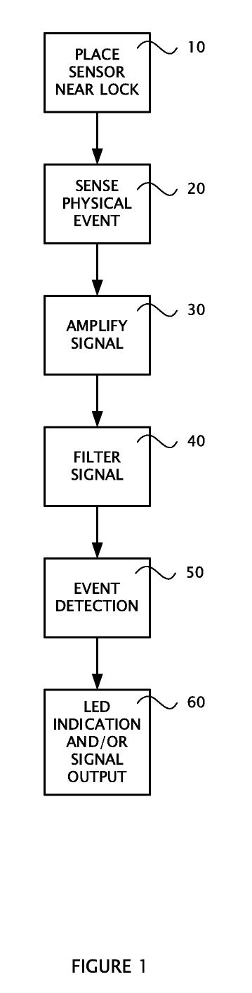

The preferred embodiments of the present invention will now be described with respect to the Figures. FIG. 1 shows a flow diagram of the method of the present invention. In step 10 a sensor is located near the lock either on or in the door or the door jamb. The sensor may for example be an acoustic sensor such as a microphone, a MEMs accelerometer, or a piezoelectric effect sensor. The sensor senses energy from a physical event such as acoustic energy, vibration, etc. (step 20). The sensed energy is converted by the sensor to electrical signals that are then processed to determine if the energy sensed is a result of an attempted lock bumping procedure. The signals from the sensor are first amplified (step 30) by a wideband low gain amplifier. The amplified signal is then filtered in step 40 by narrow-band digital or analog filters. In step 50, the detection of the attempted lock bumping takes place with reference to a set of qualifying rules and a set of disqualifying rules as explained further below. This may be accomplished by digital processing as in the preferred embodiment described below, or by analog comparator circuits also described below. Finally, in step 60, if a lock bumping event has been detected based on the rule analysis, then an LED is illuminated and/or an alarm signal is automatically transmitted to an associated security system, indicating that a lock bumping event has been detected. Alternatively, the lock bumping event detection may be stored and the signal transmitting the detected event may be transmitted only when the security device 100 has been queried by the security system (polled) as well known in the art.

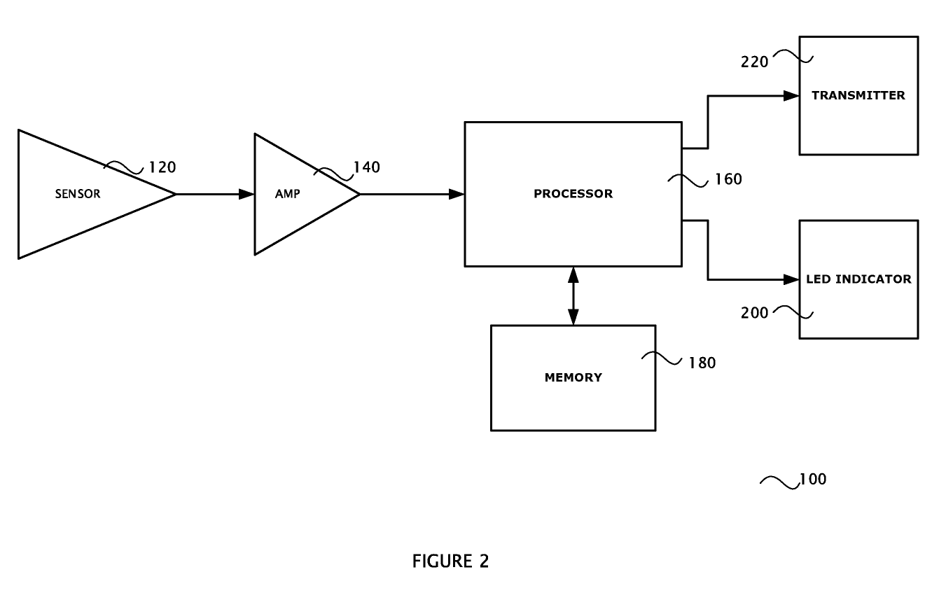

To perform steps 20 through 60, the lock bumping detection security device 100 shown in FIG. 2 may be used. The security device 100 includes a sensor 120 for sensing energy from its surrounding environment, and processing circuitry coupled to the sensor to determine if the sensed energy is a result of an attempted lock bumping procedure. The processing circuitry will analyze the sensed energy to generate a received energy signature. Then, the received energy signature is analyzed by the processor 160 with respect to qualifying rules and disqualifying rules obtained from the memory 180. If the received energy signature compares to the stored energy signature with respect to one or more of the predetermined qualifying rules, then it is determined that a lock bumping procedure has been detected. If, however, the received energy signature does not substantially match one or more of the predetermined qualifying rules, then it is determined that a lock bumping procedure has not been detected. Furthermore, if the received energy signature compares to the stored energy signature with respect to one or more of the predetermined disqualifying rules, then it is determined to not have been a lock bumping procedure. By using disqualifying rules, the possibility of a false alarm is greatly reduced if not eliminated altogether.

Qualifying rules and disqualifying rules are generated through empirical analysis and by simulating real world conditions. For example, a door may have a mail slot with a swinging metal panel that may generate sounds and vibrations that are detected by the sensor. In order to ensure that the device does not erroneously indicate that a lock bumping procedure has been attempted when the mail slot panel moves, an analysis of the signals generated by the sensor is undertaken while the mail slot panel is opened. This analysis results in a disqualifying rule that is stored for future reference. If the processor subsequently determines that a signal from the sensor provides a signature that matches this disqualifying rule, then it is concluded that the event is not a lock bumping procedure. Other disqualifying rules may be generated from similar real world situations that are known to not be lock bumping procedures. Similarly, a lock bumping procedure may be implemented in order to generate a qualifying rule, where subsequent events may be analyzed with respect to these qualifying rules.

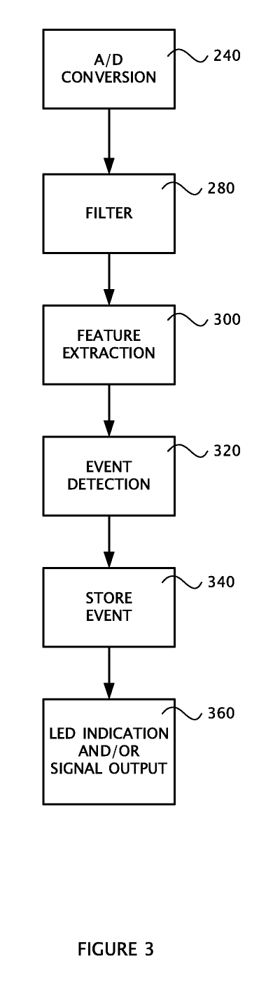

The processing circuitry includes an amp 140 for amplifying the signal from the sensor 120, a processor 160 for processing the amplified signal, memory 180 for storing data and an algorithm used for processing the signal as well as the signatures, the qualifying rules and disqualifying rules, and an LED indicator 200 and an data transmitter 220 (both for indicating a lock bumping procedure has been detected). The steps for processing the signal by the processor 160 are shown in FIG. 3. The processor 160 first digitizes the analog signal with an A/D converter in step 240. The filtering of step 280 is performed to look for energy which would correspond to the energy created by the banging of the bump key (i.e. its signature). In order to determine if the event is a lock bumping, the feature extraction algorithm of step 300 is used upon the detection of energy in step 280. The algorithm looks for a signature that would be created if lock bumping has occurred. This signature may be produced by one or more of the following events: the bump key hitting the key pins, the key pins hitting the drive pins, and/or the turning of the cylinder. The event detection algorithm of step 320 determines if the lock bumping has taken place by determining if the features extracted in step 300 are within predetermined limits (that is, if the received signal characteristics are substantially the same as a previously stored signature). If the features are within the predetermined threshold (the signature comparison is positive), then the lock bumping event is recorded in step 340 and is indicated in step 360 by an LED being illuminated and/or a signal being transmitted.

The specific filter frequencies, the feature extraction components, and the event detection criteria may be determined through trial and analysis of a variety of actual doors and locks to generate qualifying rules and disqualifying rules as stated above. That is, in order to generate the stored (i.e. baseline) signature, a lock bumping procedure is simulated on a lock and acoustic energy emanating from the lock is sensed. The sensed acoustic energy is then analyzed as described above to generate the signature, which is then stored in memory 180 for later use in analysis.

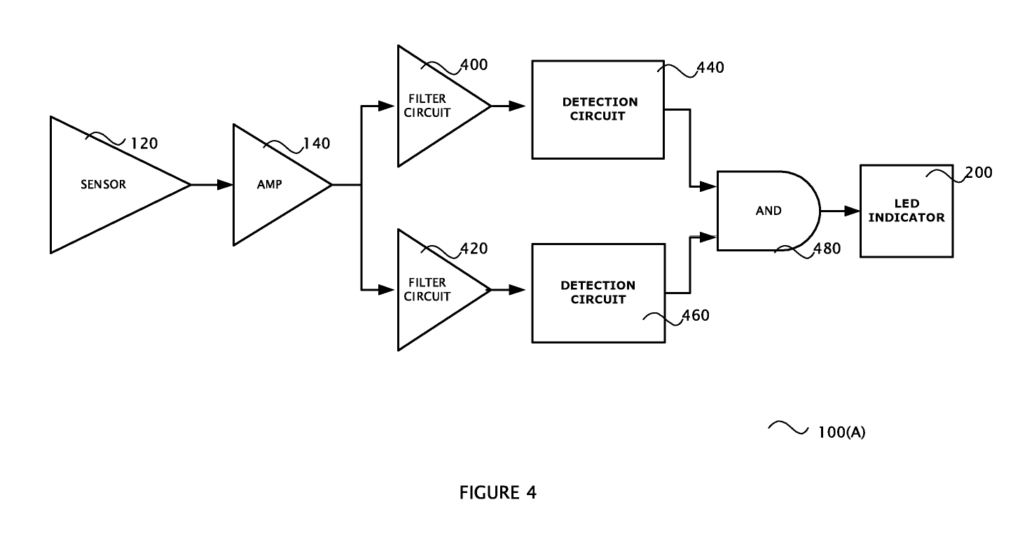

FIG. 4 shows an alternative embodiment that may be used to detect a lock bumping procedure. This embodiment uses analog electronics rather than digital processing. The security device 100(A) includes an acoustic transducer 120, an amp 140, multiple filters 400 and 420, multiple detection circuits 440 and 460, a logic AND circuit 480, and an LED indicator 200. In this embodiment the filter circuits 400 and 420 are narrow bandpass filter at selected frequencies, and the detection circuits 440 and 460 consist of threshold comparator circuits and possibly time delay circuits.

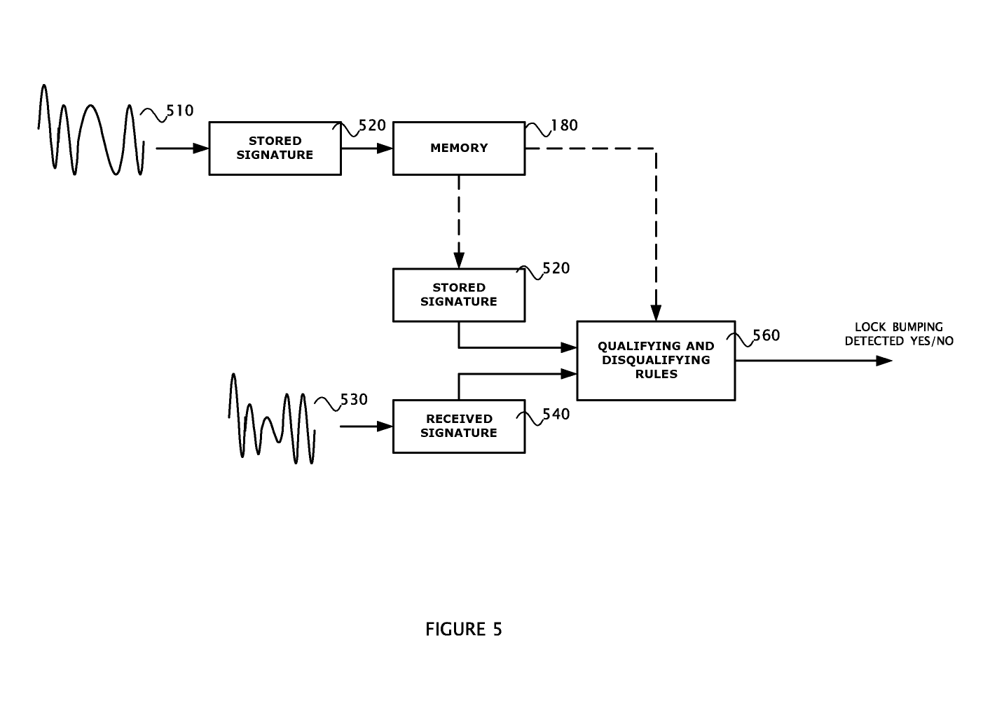

FIG. 5 illustrates in more detail the analysis of the signatures with respect to the qualifying and disqualifying rules. As part of the configuration process, a lock bumping procedure is undertaken by the installer (or at the factory) in order to generate signal 510. That signal 510 is processed as previously described and then stored as a stored signature 520 in the memory 180. During use of the device, a signal 530 is generated by the sensor and the received signature 540 is generated as previously described. The stored signature 520 is retrieved from memory for comparison with the received signature 540. Also, the qualifying rules and disqualifying rules 560 are used for a comparison basis with the stored signature 520 and the received signature 540. From this analysis, it will be determined if the lock bumping procedure has been detected and if an alarm should be sounded as previously described.

It will be apparent to those skilled in the art that modifications to the specific embodiment described herein may be made while still being within the spirit and scope of the present invention. For example the security device 100(A) in FIG. 4 may include only one filter circuit 400 and one detection circuit 440 or the security device may include multiple parallel filter circuits and detection circuits. The sensor 120 may be any sensor that can sense the energy transmitted by the banging of the key, the movement of the lock pins, and the movement of the lock cylinder. The sensor may also sense other energy components of the lock bumping besides these.

What is claimed is:

1. A method of detecting bumping of a lock on a door comprising:
a) locating a sensor near a lock on a door;
b) sensing energy emanating from the lock; and
c) processing the sensed energy to determine if the energy is a result of a lock bumping procedure.

2. The method of claim 1 further comprising the step of transmitting an alarm signal to an associated security system when it is determined that the energy is a result of a lock bumping procedure.

3. The method of claim 1 wherein said processing of the sensed energy to determine if the energy is a result of a lock bumping procedure comprises
i) analyzing the sensed energy to generate a received energy signature;
ii) comparing the received energy signature to a stored energy signature with respect to a set of predefined rules; and
iii) if the result of the comparison is positive, then indicating that the energy is a result of a lock bumping procedure.

4. The method of claim 3 wherein the predefined rules comprise qualifying rules, wherein if any of the qualifying rules are satisfied then a lock bumping procedure has been detected.

5. The method of claim 3 wherein the predefined rules comprise disqualifying rules, wherein if any of the disqualifying rules are satisfied then a lock bumping procedure has not been detected.

6. The method of claim 3 wherein the stored energy signature is obtained by
simulating a lock bumping procedure on a lock;
sensing energy emanating from the lock;
analyzing the sensed energy to generate an energy signature; and
storing the energy signature.

7. The method of claim 1 wherein the processing is carried out substantially in the digital domain.

8. The method of claim 1 wherein the processing is carried out substantially in the analog domain.

9. A lock bumping detection device comprising:
a) a sensor for sensing energy; and
b) processing circuitry coupled to the sensor and adapted to determine if the energy is a result of a lock bumping procedure.

10. The lock bumping detection device of claim 9 further comprising a transmitter for transmitting an alarm signal to an associated security system when the processing circuitry determines that the acoustic energy is a result of a lock bumping procedure.

11. The lock bumping detection device of claim 9 wherein the processing circuitry determines if the energy is a result of a lock bumping procedure by
i) analyzing the sensed energy to generate a received energy signature;
ii) comparing the received energy signature to a stored energy signature with respect to a set of predefined rules; and
iii) if the result of the comparison is positive, then indicating that the energy is a result of a lock bumping procedure.

12. The lock bumping detection device of claim 11 wherein the predefined rules comprise qualifying rules, wherein if any of the qualifying rules are satisfied then a lock bumping procedure has been detected.

13. The lock bumping detection device of claim 11 wherein the predefined rules comprise disqualifying rules, wherein if any of the disqualifying rules are satisfied then a lock bumping procedure has not been detected.

14. The lock bumping detection device of claim 11 further comprising a memory for storing the stored energy signature, and wherein the stored energy signature is obtained by
simulating a lock bumping procedure on a lock;
sensing energy emanating from the lock;
analyzing the sensed energy to generate an energy signature; and
storing the energy signature in the memory.

15. The lock bumping detection device of claim 9 wherein the sensor is an acoustic sensor.

16. The lock bumping detection device of claim 9 wherein the sensor is an accelerometer.

17. The lock bumping detection device of claim 9 wherein the sensor is a piezoelectric sensor.
